(19) United States
(12) Patent Application Publication
(10) Pub. No.: US 2020/0173176 A1
(43) Pub. Date: Jun. 4, 2020

(54) PLASTIC FLOORING HAVING BACKING AND METHOD OF MAKING THE SAME

(71) Applicant: WUXI BOYU PLASTIC MACHINERY, Jiangsu Province (CN)

(72) Inventor: DING YI LIU, Jiangsu Province (CN)

(21) Appl. No.: 16/208,199

(22) Filed: Dec. 3, 2018

(51) Int. Cl. E04F 15/02; B29C 65/00; E04F 15/10

(52) U.S. Cl. CPC E04F 15/02155; B29C 47/0019; B29C 47/0064; B29C 47/0066; B29C 47/0069; B32B 7/12; B29C 66/45; B29C 66/723; B29C 66/83413; E04F 15/105; E04F 15/107; B29C 47/067

(57) ABSTRACT

A making plastic flooring having a backing contains: a body which has a substrate, a printing layer, and an anti-abrasion layer. A method of making the plastic flooring contains steps of: (A). producing a semi-finished plastic flooring, wherein the semi-finished plastic flooring has the substrate, the printing layer, and the anti-abrasion layer; (B). moving and positioning the semi-finished plastic flooring on a predetermined position of drop plastic equipment, wherein the semi-finished plastic flooring is faced upward; (C). molding the backing, wherein the backing material is melt and is glue dispensed or is spray onto a back surface of the semi-finished plastic flooring by using drop plastic equipment, and the backing material is adhered on the back surface of the semi-finished plastic flooring after being solidified; and (D). cutting, wherein the semi-finished plastic flooring having the backing is removed and is cut into a desired size, thus producing the body.

### FIELD OF THE INVENTION

The present invention relates to plastic flooring, and more particularly a method of making the plastic flooring having backing which avoids glue coating and obtains environmental protection.

### BACKGROUND OF THE INVENTION

Conventional plastic flooring contains a substrate, a printing layer, an anti-abrasion layer, and a backing.

However, the backing is adhered in a back surface of the substrate by using a glue, thus causing pollution and troublesome fabrication.

The present invention has arisen to mitigate and/or obviate the afore-described disadvantages.

### SUMMARY OF THE INVENTION

The primary aspect of the present invention is to provide a method of making plastic flooring having backing which avoids glue coating and obtains environmental protection.

Another aspect of the present invention is to provide a plastic flooring having backing which is manufactured in various shapes by using a computer program control of the electric control system.

### BRIEF DESCRIPTION OF THE DRAWINGS

FIG. 1 is a schematic view showing equipment of making plastic flooring having backing according to a preferred embodiment of the present invention.

FIG. 2 is a schematic view showing a part of the equipment of making the plastic flooring having the backing according to the preferred embodiment of the present invention.

FIG. 3 is another schematic view showing a part of the equipment of making the plastic flooring having the backing according to the preferred embodiment of the present invention.

FIG. 4 is a schematic view showing the plastic flooring having the backing according to the preferred embodiment of the present invention.

FIG. 5 is another schematic view showing the plastic flooring having the backing according to the preferred embodiment of the present invention.

### DETAILED DESCRIPTION OF THE PREFERRED EMBODIMENTS

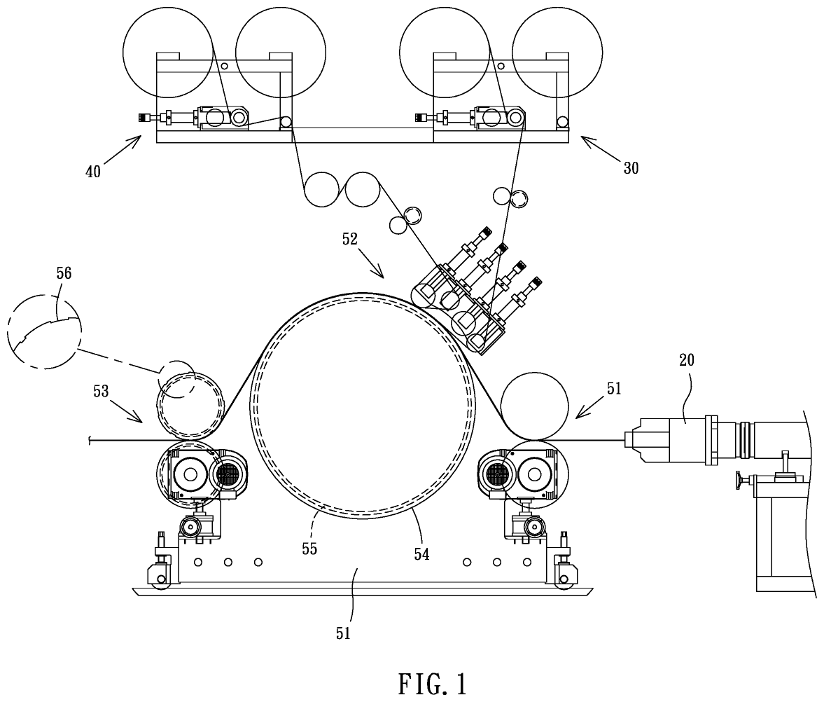

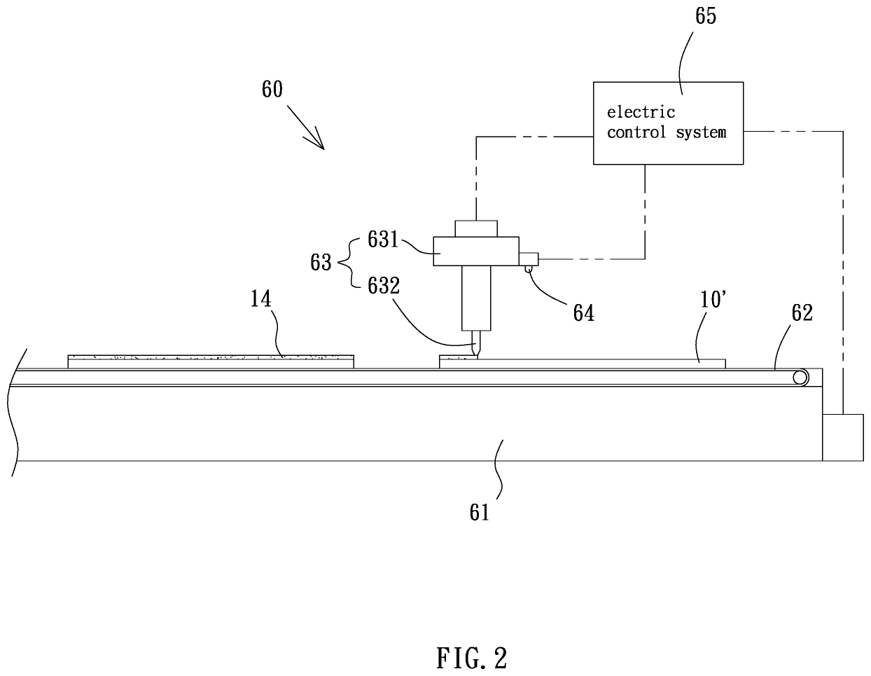

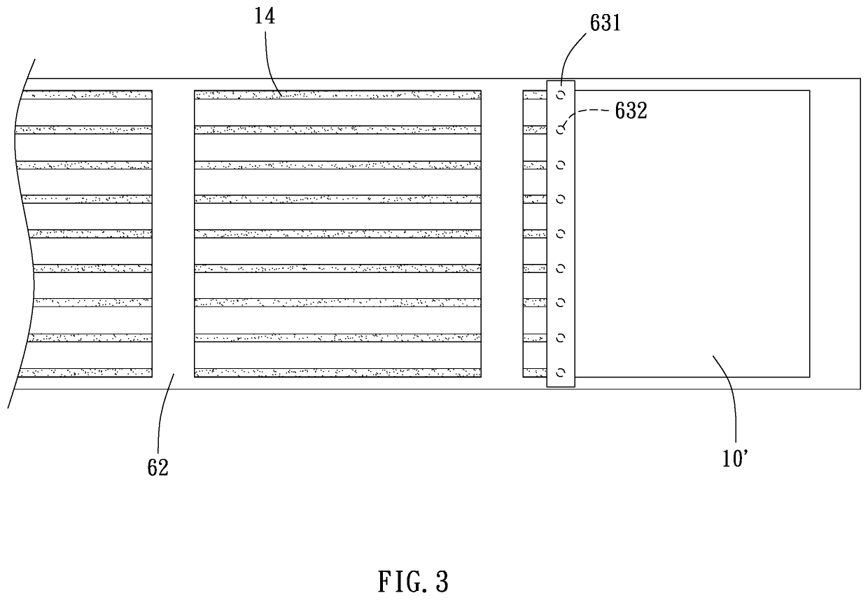

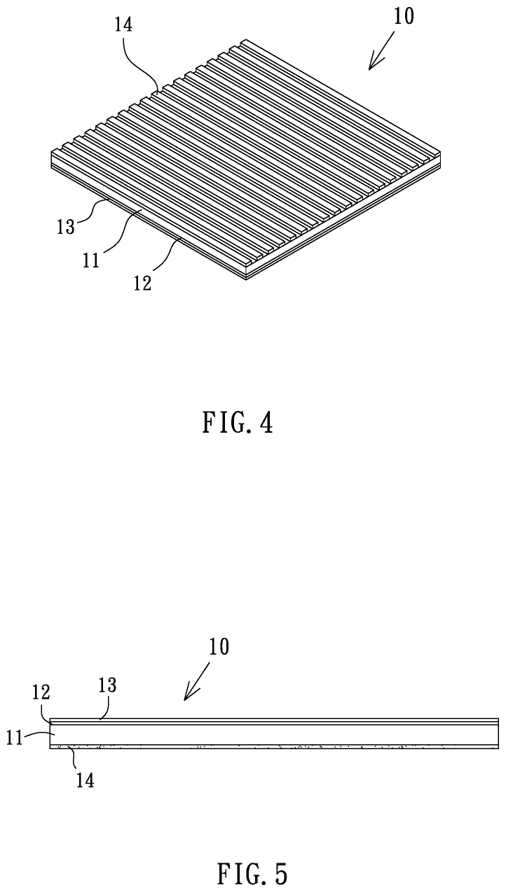

Referring further to FIGS. 1-5, plastic flooring having backing according to a preferred embodiment of the present invention comprises: a body 10 including:

a substrate 11 having a top 111 and a bottom 112;

a printing layer 12 having patterns and adhered on the top 111 of the substrate 11 after being rolled with the substrate 11;

an anti-abrasion layer 13 adhered on the printing layer 12 after being rolled with the printing layer 12;

a backing 14 made of polyvinyl chloride (PVC) or polyurethane (PU) and adhered on the bottom 112 of the substrate 11.

The printing layer 12 is adhered on the top 111 of the substrate 11, the anti-abrasion layer 13 is adhered on the printing layer 12, and the backing 14 is adhered on the bottom 112 of the substrate 11 by ways of an extruder 20, a first rolling mechanism 30, a second rolling mechanism 40, a pressing machine 50, and drop plastic equipment 60, so a method of making the plastic flooring further comprises a step of:

(A). producing a semi-finished plastic flooring 10′, wherein the substrate 11 is extrusion molded by using the extruder 20 and is transported to the pressing machine 50, the printing layer 12 is delivered to the pressing machine 50 by ways of the first rolling mechanism 30, and the anti-abrasion layer 13 is conveyed to the pressing machine 50 by mean of the second rolling mechanism 40, wherein the substrate 11, the printing layer 12, and the anti-abrasion layer 13 are pressed together by using the pressing machine 50, thus producing the semi-finished plastic flooring 10′.

The pressing machine 50 is a five-roller pressing machine, and the pressing machine 50 includes a pedestal 57 on which a thick rolling set 51, a contact rolling set 52, and a press rolling set 53 are arranged.

The thickness rolling set 51 has two rollers fixed beside a first side of the contact rolling set 52, and a contacting position of the two thickness rollers aligns with an outlet of the extruder 20 so as to limit a thickness of the substrate 11.

The contact rolling set 52 has a contacting roller 54, multiple guiding rollers arranged around the contacting roller 54, a heating unit 55 accommodated in the contacting roller 54, wherein the heating unit 55 has multiple pipes connected with an external device (not shown) so that hot oil flows to the heating unit 55 from the external device via the multiple pipes, by which the substrate 11, the printing layer 12, and the anti-abrasion layer 13 are heated.

The press rolling set 53 is mounted beside a second side of the contact rolling set 52, and the press rolling set 53 has two opposite pressing rollers configured to roll and press the substrate 11, the printing layer 12, and the anti-abrasion layer 13 together, wherein one of the two opposite pressing rollers has embossing section 56 formed thereon so that the anti-abrasion layer 13 has distinguished pressing patterns after pressing the substrate 11, the printing layer 12, and the anti-abrasion layer 13.

The method of making the plastic flooring further comprises a step of:

(B). moving and positioning the semi-finished plastic flooring 10′, wherein the semi-finished plastic flooring 10′ is cut into multiple sheets in a predetermined size and is put on a predetermined position of the drop plastic equipment 60, wherein a back surface of the semi-finished plastic flooring 10′ faces upward. The drop plastic equipment 60 includes a base 61 on which a delivery mechanism 62 is secured, wherein the delivery mechanism 62 is a delivery belt configured to deliver and hold the semi-finished plastic flooring 10′. The drop plastic equipment 60 further includes at least one molding mechanism 63 and at least one sensing element 64 which are located above the base 61 and opposite to the delivery mechanism 62, wherein the at least one molding mechanism 63 has a material collector 631 and at least one material feeder 632 mounted on a bottom of the material collector 631, wherein the material collector 631 accommodates backing material fed by an external supply device, and the material feeder 632 feeds the backing material. The backing material is melt, and the backing material is made of polyvinyl chloride (PVC) or polyurethane (PU). The at least one molding mechanism 63 is movable or is fixed. When the at least one molding mechanism 63 is movable, it has one material feeder 632 which is controlled by an electric control system 65 to move. When the at least one molding mechanism 63 is fixed, it has multiple material feeders 632 which are fixed at a predetermined position. For example, in this embodiment, the at least one molding mechanism 63 is fixed and has the multiple material feeders 632. The sensing element 64 is an infrared radiation (IR) sensor and is disposed on a side of the material collector 631. When the semi-finished plastic flooring 10′ is delivered to pass through and located below the sensing element 64, the sensing element 64 transmits a signal to the electric control system 65 so that the electric control system 65 controls the molding mechanism 63 to spray the backing material onto the semi-finished plastic flooring 10′.

The method of making the plastic flooring further comprises a step of:

(C). molding the backing 14, wherein the backing material is glue dispensed or is spray onto the back surface of the semi-finished plastic flooring 10′ by using the molding mechanism 63 of the drop plastic equipment 60, and the backing material is adhered on the back surface of the semi-finished plastic flooring 10′ after being solidified. When the backing material is sprayed onto the back surface of the semi-finished plastic flooring 10′, its distribution shape, position, and size are set by ways of the electric control system 65. For example, the backing material is sprayed onto the back surface of the semi-finished plastic flooring 10′ in a sheet shape or multiple spaced strap shape.

Furthermore, the backing material is sprayed onto the semi-finished plastic flooring 10′ in a normal temperature and a low pressure, and the semi-finished plastic flooring 10′ is put into a heating chamber to be heat at a temperature of 100° C. to 130° C. Thereafter, the semi-finished plastic flooring 10′ is removed from the heating chamber and is cooled in the normal temperature. Alternatively, the backing material is sprayed onto the semi-finished plastic flooring 10′ by using the at least one molding mechanism 63 in a high pressure and a high temperature, and the semi-finished plastic flooring 10′ is cooled in the normal temperature. In another embodiment, the backing 14 is molded in a roll coating manner.

The method of making the plastic flooring further comprises a step of:

(D). cutting, wherein the semi-finished plastic flooring 10′ having the backing 14 is removed and is cut into a desired size, thus producing the body 10.

Thereby, the backing 14 is adhered on the bottom of the body 10 in a spring manner, thus avoid glue coating and obtaining environmental protection. The backing 14 is molded by using a computer program control of the electric control system 65 in various shapes.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of making plastic flooring having a backing comprising steps of:
(A). producing a semi-finished plastic flooring, wherein the semi-finished plastic flooring has a substrate, a printing layer, and an anti-abrasion layer;
(B). moving and positioning the semi-finished plastic flooring on a predetermined position of drop plastic equipment, wherein the semi-finished plastic flooring is faced upward;
(C). molding the backing, wherein the backing material is melt and is glue dispensed or is spray onto a back surface of the semi-finished plastic flooring by using drop plastic equipment, and the backing material is adhered on the back surface of the semi-finished plastic flooring after being solidified; and
(D). cutting, wherein the semi-finished plastic flooring having the backing is removed and is cut into a desired size, thus producing the body.

2. The method as claimed in claim 1, wherein in the step of A, the substrate is extrusion molded by using the extruder and is transported to the pressing machine, the printing layer is delivered to the pressing machine by ways of the first rolling mechanism, and the anti-abrasion layer is conveyed to the pressing machine by mean of the second rolling mechanism, wherein the substrate, the printing layer, and the anti-abrasion layer are pressed together by using the pressing machine, thus producing the semi-finished plastic flooring.

3. The method as claimed in claim 2, wherein the pressing machine is a five-roller pressing machine, and the pressing machine includes a pedestal on which a thick rolling set, a contact rolling set, and a press rolling set are arranged;
wherein the thickness rolling set has two rollers fixed beside a first side of the contact rolling set, and a contacting position of the two thickness rollers aligns with an outlet of the extruder so as to limit a thickness of the substrate;
wherein the contact rolling set has a contacting roller, multiple guiding rollers arranged around the contacting roller;
wherein the press rolling set is mounted beside a second side of the contact rolling set, and the press rolling set has two opposite pressing rollers configured to roll and press the substrate, the printing layer, and the anti-abrasion layer together, wherein one of the two opposite pressing rollers has embossing section formed thereon so that the anti-abrasion layer has distinguished pressing patterns after pressing the substrate, the printing layer, and the anti-abrasion layer.

4. The method as claimed in claim 1, wherein in the step of B, the semi-finished plastic flooring is cut into multiple sheets in a predetermined size and is put on the drop plastic equipment.

5. The method as claimed in claim 1, wherein the drop plastic equipment includes a base on which a delivery mechanism is secured, wherein the delivery mechanism is a delivery belt configured to deliver and hold the semi-finished plastic flooring; the drop plastic equipment further includes a molding mechanism located above the base and opposite to the delivery mechanism, wherein the molding mechanism has a material collector and at least one material feeder mounted on a bottom of the material collector, wherein the molding mechanism is controlled by an electric control system so that when the semi-finished plastic flooring is delivered to the predetermined position, the electric control system controls the molding mechanism to spray the backing material onto the semi-finished plastic flooring.

6. The method as claimed in claim 1, wherein the backing is made of polyvinyl chloride (PVC) or polyurethane (PU).

7. The method as claimed in claim 7, wherein the backing is made of polyvinyl chloride (PVC) or polyurethane (PU).

8. The method as claimed in claim 5, wherein the backing material is sprayed onto the semi-finished plastic flooring in a normal temperature and a low pressure, and the semi-finished plastic flooring is put into a heating chamber to be heat, then the semi-finished plastic flooring is removed out of the heating chamber and is cooled in the normal temperature.

9. The method as claimed in claim 5, wherein the backing material is sprayed onto the semi-finished plastic flooring by using the molding mechanism in a high pressure and a high temperature, and the semi-finished plastic flooring 10′ is cooled in the normal temperature.

10. A plastic flooring having the backing comprising:
a substrate having a top and a bottom;
a printing layer having patterns and adhered on the top of the substrate;
an anti-abrasion layer adhered on the printing layer; and
a backing made of polyvinyl chloride (PVC) or polyurethane (PU) and adhered on the bottom of the substrate.

11. The plastic flooring having the backing as claimed in claim 10, wherein the backing is made of polyvinyl chloride (PVC) or polyurethane (PU).

12. The plastic flooring having the backing as claimed in claim 10, wherein the backing material is sprayed onto the bottom of the substrate in a sheet shape or multiple spaced strap shape.
